(19) United States
(12) Patent Application Publication
(10) Pub. No.: US 2024/0083630 A1
(43) Pub. Date: Mar. 14, 2024

(54) DIVIDER SYSTEM FOR GLOVE BOX ORGANIZER

(71) Applicant: Guangzhou Yiliang Trading Co., Ltd., Guangzhou (CN)

(72) Inventor: Shuzhi CHEN, (US)

(73) Assignee: Guangzhou Yiliang Trading Co., Ltd., Guangzhou (CN)

(21) Appl. No.: 17/932,286

(22) Filed: Sep. 14, 2022

(51) Int. Cl. B65D 25/04; B60R 7/06

(52) U.S. Cl. CPC B65D 25/04; B60R 7/06

(57) ABSTRACT

The present disclosure provides a divider system for a glove box organizer, including a mating piece, at least one first joining piece and at least one second joining piece, where the mating piece can form a X joint with the first joining piece, and form a T joint with the second joining piece; and the divider system for a glove box organizer includes at least one X joint and at least one T joint. The divider system for a glove box organizer makes it possible to store some rarely used tools which may hardly be spotted, such as car manuals, car maintenance tools, and umbrellas. The divider system for a glove box organizer is simple in structure, convenient to install, and easy to operate.

### TECHNICAL FIELD

The present disclosure relates to automobile parts, and in particular, to a divider system for a glove box organizer.

### BACKGROUND

With the development of society, people are brought closer to each other. Thus, more people are using cars for commute. As the car uses increase, glitches may unavoidably occur now and then. In this circumstance, there is no need to call car maintenance shops. Rather, what the driver needs most is a car manual, some maintenance tools and so on. Therefore, it is necessary to have a special place called glove box to store rarely used tools. At present, a glove box is embedded above the front passenger's footwell, which, however, usually has limited space for people to store those rarely used tools. It is thus desirable to reasonably utilize space in the glove box organizer.

A plate structure is disclosed in U.S. Patent Application Publication No. 11305699, which can be added to a glove box to divide the glove box into spaces of different sizes, so as to realize the space utilization of the glove box organizer. However, achieving reasonable space utilization alone is not enough. A stable space for the glove box is also required. And the T-shaped plate structure with edge openings as disclosed in U.S. Patent Application Publication No. 11305699 has poor stability. In view of this, an objective of the present disclosure is to design a divider system for a glove box organizer which has a structure different from the foregoing plate structure and can ensure high stability and reasonable space utilization.

### SUMMARY

The technical problem to be solved by the present disclosure is to provide a divider system for a glove box organizer which has a more stable structure than that of an divider system for a glove box organizer in the prior art, so as to solve the problem of low space utilization of an existing glove box divider.

To solve the above technical problem, an embodiment of the present disclosure provides a divider system for a glove box organizer, the divider system for a glove box organizer including:
a mating piece including at least one first female mating feature, at least one second female mating feature, a substantially planar upper surface, and a substantially planar lower surface;
at least one first joining piece including a substantially planar left surface, a substantially planar right surface, a first male joining feature, an upper joining piece and a lower joining piece, where the first joining piece is integrally formed;
and at least one second joining piece including a substantially planar left surface, a substantially planar right surface, and a second male joining feature;
where the first male joining feature is connected with the first female mating feature to form a X joint; and the second male joining feature is connected with the second female mating feature to form a T joint.

Preferably, a first slot is provided in the first female mating feature, and has a length equal to a width of the lower joining piece and greater than half of a length of the first female mating feature.

Preferably, at least one second slot is provided in the second female mating feature, and has a length less than half of a length of the second female mating feature.

Preferably, each of the first female mating feature and the second female mating feature is provided with a protrusion arranged on the upper surface of the mating piece.

Preferably, at least one internal angle of the mating piece is an acute angle.

Preferably, the mating piece has a thickness ranging between 1.5 mm and 3 mm.

Preferably, a thickness of the first joining piece is equal to a thickness of the second joining piece and not greater than the thickness of the mating piece.

Preferably, the first joining piece is structurally provided with the upper joining piece, the first male joining feature and the lower joining piece from top to bottom; and the size of the upper joining piece is different from that of the lower joining piece.

Preferably, the lower joining piece is located beneath the lower surface of the mating piece, and the upper joining piece is located on the upper surface of the mating piece.

Preferably, at least one internal angle of each of the first joining piece and the second joining piece is an obtuse angle.

Preferably, each second joining piece is located on the upper surface of the mating piece.

The embodiment of the present disclosure has the following beneficial effects:
(1) In the divider system for a glove box organizer, a X joint formed by connecting the mating piece and the integrally-formed first joining piece is adopted as the main supporting structure, thereby enhancing the load-bearing capacity of the divider system for a glove box organizer, and keeping the structure in the face of various kinds of severe vibration.
(2) The divider system for a glove box organizer includes the mating piece, the first joining piece and the second joining piece, and a X joint and a T joint are interlaced, thus realizing the reasonable optimization and full use of the space of the glove box organizer.

### BRIEF DESCRIPTION OF THE DRAWINGS

To describe the technical solutions in the embodiments of the present disclosure or in the prior art more clearly, the following briefly describes the drawings required for describing the embodiments or the prior art. Apparently, the drawings in the following description show merely some embodiments of the present disclosure, and a person of ordinary skill in the art may still derive other drawings from these drawings without creative efforts.

FIG. 1 is a combined view according to a first embodiment of the present disclosure;

FIG. 2 is an exploded view according to a first embodiment of the present disclosure;

FIG. 3 is a structural view of an upper surface of a mating piece according to a first embodiment of the present disclosure;

FIG. 4 is a structural view of a lower surface of a mating piece according to a first embodiment of the present disclosure;

FIG. 5 is a partially enlarged view of a first female mating feature of a mating piece according to a first embodiment of the present disclosure;

FIG. 6 is a partially enlarged view of a second female mating feature of a mating piece according to a first embodiment of the present disclosure;

FIG. 7 is a structural view of a first joining piece according to a first embodiment of the present disclosure; and

FIG. 8 is a structural view of a second joining piece according to a first embodiment of the present disclosure.

Reference Numerals: 10. mating piece, 10a. upper surface of the mating piece, 10b. lower surface of the mating piece, 101. first female mating feature, 102. second female mating feature, 103. protrusion, A1. internal angle of the mating piece, T1. thickness of the mating piece, 1011. first slot, 1021. second slot, L1. length of the first female mating feature, L2—length of the first slot, L3. length of the second female mating feature, L4. length of the second slot, 20. first joining piece, 201. upper joining piece, 202. first male joining feature, 203. lower joining piece, A2. internal angle of the first joining piece, T2. thickness of the first joining piece, W1. width of the lower joining piece, 30. second joining piece, 301. second male joining feature, A3. internal angle of the second joining piece, T3. thickness of the second joining piece, 3011. tooth, 40. X joint, and 50. T joint.

### DETAILED DESCRIPTION OF THE EMBODIMENTS

The technical solutions in the embodiments of the present disclosure will be described below clearly and completely with reference to the accompanying drawings in the embodiments of the present disclosure. Apparently, the described embodiments are merely some rather than all of the embodiments of the present disclosure. All other embodiments obtained by a person of ordinary skill in the art based on the examples of the present disclosure without creative efforts shall fall within the protection scope of the present disclosure.

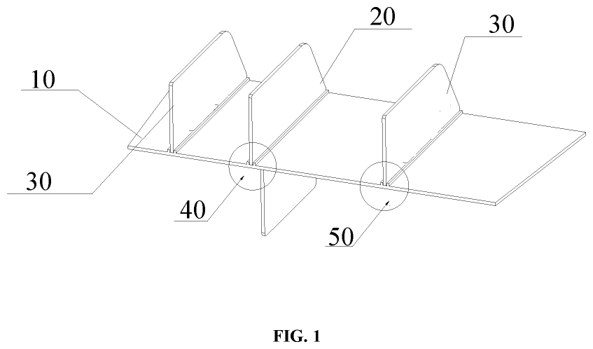

Referring to FIG. 1, an embodiment of the present disclosure provides a divider system for a glove box organizer, including a mating piece 10, a first joining piece 20 and a second joining piece 30. The mating piece 10, as a cross beam constituting the embodiment of the present disclosure, is one of the main supporting parts of the embodiment of the present disclosure; the first joining piece 20, as a vertical beam constituting the embodiment of the present disclosure, is one of the main supporting parts of the embodiment of the present disclosure, which is integrally formed to ensure the stability of the vertical beam; and the second joining piece 30, as an auxiliary component constituting the embodiment of the present disclosure, is used to assist the embodiment of the present disclosure in forming more compartments. The mating piece 10 is connected with the first joining piece 20 to form the X joint 40 as a main support of the embodiment. In addition, a plurality of first joining pieces 20 may be provided to constitute the main supports of the embodiment together with the mating piece. The second joining piece 30 is connected with the mating piece 10 to form the T joint 50 around the X joint 40, such that the closed space in a glove box is finely divided to form the divider system for a glove box organizer. The upper and lower surfaces of the mating piece 10 are substantially planar, the left and right surfaces of the first joining piece 20 are substantially planar, and the left and right surfaces of the second joining piece 30 are substantially planar. In this way, waste of space in the formed divider system for a glove box organizer due to protruding surfaces is avoided, and poor structural strength because of the concave surfaces can also be avoided. Each additional first joining piece 20 may increase two spaces; every two additional second joining pieces 30 may increase one space; and the first joining piece 20 and the second joining piece 30 are added as needed, such that the optimal use of the space in the glove box can be realized.

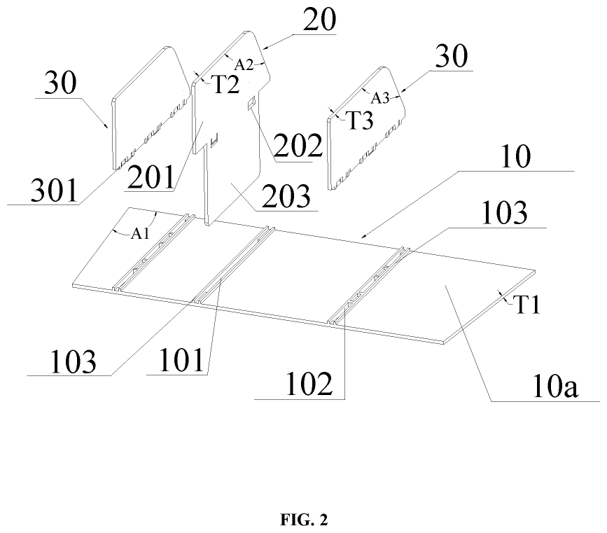

Referring to FIG. 2, the mating piece 10 includes a first female mating feature 101, a second female mating feature 102 and a protrusion 103; the first joining piece 20 includes an upper joining piece 201, a first male joining feature 202, and a lower joining piece 203; and the second joining piece 30 includes a second male joining feature 301. The first female mating feature 101 is connected with the first male joining feature 202 to form the X joint 40; and the second female mating feature 102 is connected with the second male joining feature 301 to form the T joint 50. The protrusion 103 is further provided on the mating piece 10, which is a raised baffle located on the left and right sides of the first female mating feature 101 and the second female mating feature 102. After the formation of the X joint 40 by the first joining piece 20 and the mating piece 10, and the formation of the T joint 50 by the second joining piece 30 and the mating piece 10, the upper joining piece 201 and the second joining piece 30 are then secured by the protrusion 103, such that the X joint 40 and the T joint 50 are kept stable without shaking, deformation or other problems.

The first male joining feature 202 is a part for clamping the first female mating feature, the upper joining piece 201 is a part of the first joining piece 20 located on the first male joining feature 202, and the lower joining piece 203 is part of the first joining piece 20 located under the first male joining feature 202. After the first male joining feature 202 is connected with the first female mating feature 101, the upper joining piece 201 is used to divide the upper space of the mating piece 10, and the lower joining piece 203 is used to divide the lower space of the mating piece 10. Each additional first joining piece 20 divides the space of the mating piece 10 into upper and lower halves at the same time, thus yielding two additional spaces.

The second male joining feature 301 is a part for clamping the second female mating feature. The second joining piece is always in the upper space of the mating piece 10, which divides the upper space of the mating piece into two halves to thus yield an additional space.

The mating piece 10 further has a thickness T1 ranging between 1.5 mm and 3 mm. A thickness T2 of the first joining piece 20 is equal to a thickness T3 of the second joining piece 30, and is not greater than the thickness of the mating piece 10. The thickness can not only ensure the sufficient strength of the divider system for a glove box organizer, but also ensure that the divider system for a glove box organizer occupies a large proportion of space inside the glove box organizer. The mating piece further has an internal angle A1 less than 180° inside the mating piece 10. The first joining piece 20 and the second joining piece 30 may also have an internal angle, where the internal angle A2 of the first joining piece is an angle less than 180° inside the first joining piece 20, and the internal angle A3 of the second joining piece is an angle less than 180° inside the second joining piece 30. At least one internal angle A1 of the mating piece is less than 90°, such that one side of the mating piece 10 tilts; at least one internal angle A2 of the first joining piece is greater than 90°, such that the top or bottom of the first joining piece tilts; and at least one internal angle A3 of the second joining piece is greater than 90°, such that the top of the second joining piece tilts. This allows for easier access to the glove box, and secures greater portions of the mating piece 10, the first joining piece 20 and the second joining piece 30 held in the glove box, thereby improving their stability in the glove box organizer.

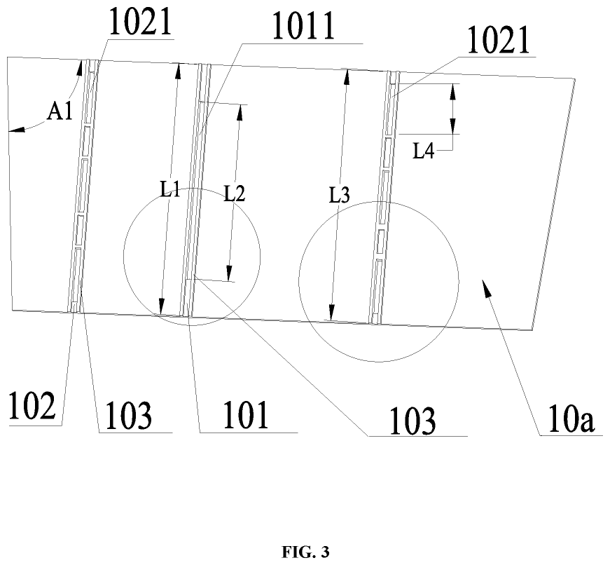

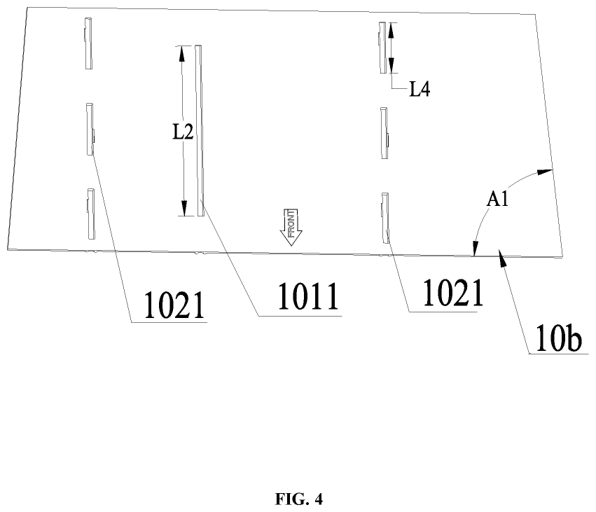

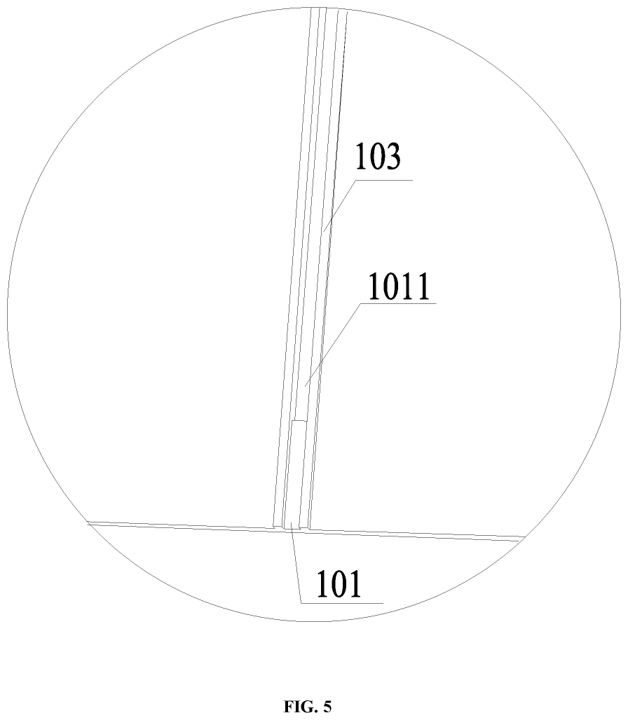

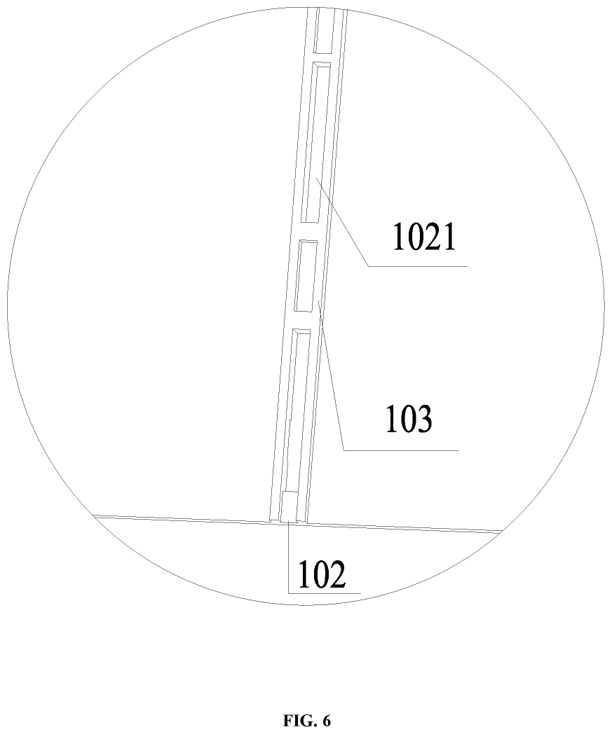

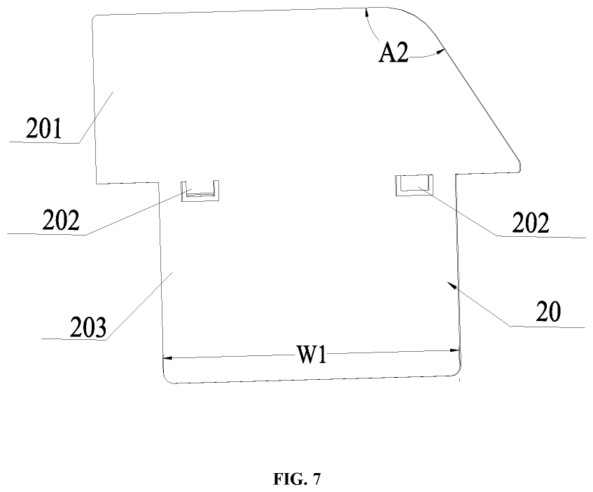

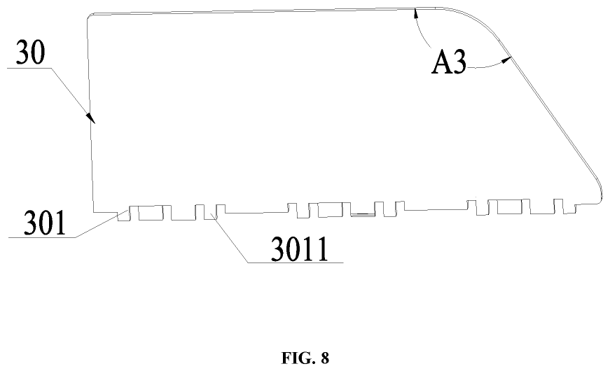

Referring to FIG. 3 and FIG. 4, the mating piece 10 further includes an upper surface 10a of the mating piece and a lower surface 10b of the mating piece, and the protrusion 103 is located on the upper surface 10a of the mating piece. Referring to FIG. 5, the first female mating feature 101 further includes a first slot 1011, a regular hole formed by hollowing out the middle of the first female mating feature, where the first slot 1011 has a length L2 greater than half of the length of the first female mating feature L3. Referring to FIG. 7, the lower joining piece 203 further includes a width W1 of the lower joining piece plate, and the length L2 of the first slot is equal to the width W1 of the lower joining piece plate. While the first joining piece 20 is connected with the mating piece 10 to form the X joint 40, the lower joining piece 203 passes through the first slot 1011; and the first male joining feature 202 tightly holds the first female mating feature 101 to form the X joint. For the first joining piece 20, the upper joining piece 201 is wider than the lower joining piece 203, such that the mating piece can be forcefully held. The first joining piece 20 is integrally formed, and the X joint formed by the insertion into the first slot 1011 allows for a more stable structure which may bear more weight, and can keep the initial shape without deformation in the face of various shakes. The second female mating feature 102 also includes a second slot 1021, and as seen in FIG. 6, the second slot 1021 is a regular hole formed by hollowing out the middle of the second female mating feature. There are generally 2-3 slots 1021, and 1-4 slots in rare cases; and the length L4 of the second slot 1021 is less than half of the length L3 of the second female mating feature. Referring to FIG. 8, the second male joining feature 301 includes teeth 3011 of various sizes. When the second male joining feature 301 is tightly connected with the second female mating feature 102, the longer teeth 3011 are connected with the second slot 1021, and the shorter teeth are connected with the second female mating feature 102 except the second slot to form the T joint 50. The T joint 50 is located on both sides of the X joint 40 to divide the space divided by the X joint 40 in a finer manner, so as to realize the reasonable optimization of the glove box organizer.

The above disclosed is only preferred embodiments of the present disclosure, and definitely should not be used to limit the scope of the claims of the present disclosure. A person of ordinary skill in the art can understand all or some of the procedures for implementing the foregoing embodiments and make equivalent changes according to the claims of the present disclosure. The equivalent changes still fall within the scope of the present disclosure.

What is claimed is:

1. A divider system for a glove box organizer, comprising:
a mating piece comprising at least one first female mating feature, at least one second female mating feature, a substantially planar upper surface, and a substantially planar lower surface;
at least one first joining piece comprising a substantially planar left surface, a substantially planar right surface, a first male joining feature, an upper joining piece and a lower joining piece, wherein the first joining piece is integrally formed;
and at least one second joining piece comprising a substantially planar left surface, a substantially planar right surface, and a second male joining feature;
wherein the first male joining feature is connected with the first female mating feature to form a X joint; and the second male joining feature is connected with the second female mating feature to form a T joint.

2. The divider system according to claim 1, wherein a first slot is provided in the first female mating feature, and has a length equal to a width of the lower joining piece and greater than half of a length of the first female mating feature.

3. The divider system according to claim 1, wherein at least one second slot is provided in the second female mating feature, and has a length less than half of a length of the second female mating feature.

4. The divider system according to claim 1, wherein each of the first female mating feature and the second female mating feature is provided with a protrusion arranged on the upper surface of the mating piece.

5. The divider system according to claim 1, wherein at least one internal angle of the mating piece is an acute angle.

6. The divider system according to claim 1, wherein the mating piece has a thickness ranging between 1.5 mm and 3 mm.

7. The divider system according to claim 1, wherein a thickness of the first joining piece is equal to a thickness of the second joining piece and not greater than the thickness of the mating piece.

8. The divider system according to claim 1, wherein the first joining piece is structurally provided with the upper joining piece, the first male joining feature and the lower joining piece from top to bottom; and the size of the upper joining piece is different from that of the lower joining piece.

9. The divider system according to claim 1, wherein the lower joining piece is located beneath the lower surface of the mating piece, and the upper joining piece is located on the upper surface of the mating piece.

10. The divider system according to claim 1, wherein at least one internal angle of each of the first joining piece and the second joining piece is an obtuse angle.

11. The divider system according to claim 1, wherein the second joining piece is located on the upper surface of the mating piece.
